(19) United States
(12) Patent Application Publication
(10) Pub. No.: US 2009/0009733 A1
(43) Pub. Date: Jan. 8, 2009

(54) EXPOSURE APPARATUS

(75) Inventor: Tomomi Funayoshi, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/167,878

(22) Filed: Jul. 3, 2008

(30) Foreign Application Priority Data
Jul. 6, 2007 (JP) 2007-178006
Jun. 18, 2008 (JP) 2008-159384

(51) Int. Cl. G03B 27/42; G03B 27/52

(52) U.S. Cl. 355/30; 355/53

(57) ABSTRACT

An exposure apparatus has a projection optical system configured to project light from a reticle onto a wafer and exposes the wafer to the light in a state where a gap between the projection optical system and the wafer is filled with liquid. In the exposure apparatus, a chuck for holding the wafer has a contact portion that is contactable with the wafer. At least this contact portion of the chuck has a hydrophilic surface having a contact angle of 90° or less with respect to the liquid.

### BACKGROUND OF THE INVENTION

1. Field of the Invention

The present invention relates to a liquid-immersion exposure apparatus that has a projection optical system configured to project light from an original onto a substrate and that exposes the substrate to the light in a state where a gap between the projection optical system and the substrate is filled with liquid.

2. Description of the Related Art

Projection exposure apparatuses that have been commonly used are configured to project circuit patterns drawn on originals, such as reticles and masks, onto substrates, such as wafers and glass plates, by exposure through projection optical systems. In recent years, high-quality exposure apparatuses with high resolution are in greater demand.

In the past, the miniaturization and enhancement of performance in exposure apparatuses have been achieved by shortening the wavelength of exposure light used in the exposure apparatuses. As a result, the light sources used in exposure apparatuses have been changed from g-line light sources to i-line light sources, and then from i-line light sources to excimer lasers. In addition, the numerical aperture of projection optical systems has been increased to achieve higher resolution.

As an example of a technology for enhancing the resolution of optical microscopes, a liquid immersion method is known. The enhancement of resolution in this method is achieved by filling the space between the objective lens and the sample to be observed with a liquid having high refractive index (see D. W. Pohl, W. Denk & M. Lanz, Appl. Phys., Lett. 44652 (1984)).

For further miniaturization and enhancement of performance in exposure apparatuses, this liquid immersion method can be applied to a semiconductor-device miniaturization process (see U.S. Pat. No. 5,121,256). Examples of a liquid immersion method include an immersion method in which the final surface of the projection optical system and the entire substrate are both immersed in a liquid bath (see EP 0023231A1 and Japanese Patent Laid-Open No. 06-124873), and a so-called local-fill method in which a liquid is only filled in a space between the projection optical system and the substrate (see WO 9949504).

The following is a description of an exposure apparatus applying the former method in which the final surface of the projection optical system and the entire substrate are both immersed in a liquid bath.

FIG. 10 schematically illustrates a liquid-immersion exposure apparatus 800 of related art. A reticle 820 having a circuit pattern drawn thereon is illuminated with a light beam from a light source (not shown) through an illumination system 810. The illumination system 810 is configured to shape the light beam from the light source to allow for uniform intensity distribution. The pattern on the reticle 820 is reduced in size by a projection optical system 830 before being projected onto a wafer 840. The projection optical system 830 and the wafer 840 have an immersion liquid 860 filled therebetween. An immersion-liquid retaining container 870 for retaining the immersion liquid 860 is disposed so as to accommodate the wafer 840 and a wafer stage 850. The immersion liquid 860 can be supplied to and recovered from the immersion-liquid retaining container 870. If the wafer 840 is to be entirely exposed to light, the exposure process is performed by moving the immersion-liquid retaining container 870. To replace the current wafer with another, a wafer conveyor arm is inserted into the immersion-liquid retaining container 870 in order to feed and retrieve wafers to and from the immersion-liquid retaining container 870. Another way to replace the current wafer with another is by moving the immersion-liquid retaining container 870 downward in FIG. 10, pushing the wafer 840 upward with, for example, a pin, and then passing the wafer 840 to the wafer conveyor arm.

In the liquid-immersion exposure apparatus where the final surface of a projection optical system and the entire substrate are both immersed in a liquid bath, the wafer is entirely immersed in liquid. For this reason, when moving the wafer within the exposure apparatus, the wafer may still have the liquid attached to the undersurface thereof. This can cause the liquid to spatter in the exposure apparatus, resulting in, for example, rusting of metallic components.

Concerning a local-fill liquid-immersion exposure apparatus, when exposing a peripheral region of the wafer to light, the edge of the wafer comes into contact with the liquid. For this reason, there is a high possibility that the liquid may flow to the undersurface of the wafer. Therefore, similar to the above, the wafer would still have the liquid attached to the undersurface thereof while being moved within the exposure apparatus. Likewise, this may cause the liquid to spatter in the exposure apparatus, thus may result in, for example, rusting of metallic components.

### SUMMARY OF THE INVENTION

The present invention provides an exposure apparatus that is resistant to failure even when a liquid spatters or flows to areas other than the surface of a wafer.

According to an aspect of the present invention, an exposure apparatus is provided. The exposure apparatus has a projection optical system configured to project light from an original onto a substrate and that exposes the substrate to the light in a state where a gap between the projection optical system and the substrate is filled with liquid. In the exposure apparatus, a chuck for holding the substrate has a contact portion that is contactable with the substrate. At least this contact portion of the chuck has a surface having a contact angle of 90° or less with respect to the liquid.

Further features of the present invention will become apparent from the following description of exemplary embodiments with reference to the attached drawings.

### BRIEF DESCRIPTION OF THE DRAWINGS

FIG. 1 illustrates a liquid-immersion exposure apparatus according to a first embodiment of the present invention.

FIG. 2 shows a wafer and an immersion-liquid retaining plate included in the liquid-immersion exposure apparatus shown in FIG. 1, as viewed from the reticle side.

FIG. 3 illustrates a distribution state of a hydrophilic property (or a hydrophilic porous material) in an immersion-liquid retaining region.

FIG. 4 illustrates a liquid-immersion exposure apparatus according to a second embodiment of the present invention.

FIG. 5 shows a wafer and an immersion-liquid retaining plate included in the liquid-immersion exposure apparatus shown in FIG. 4, as viewed from the reticle side.

FIG. 6 illustrates a liquid-immersion exposure apparatus according to a third embodiment of the present invention.

FIG. 7 is a schematic plan view of the liquid-immersion exposure apparatus shown in FIG. 6.

FIG. 8 is a flow chart of a device manufacturing method according to a fourth embodiment of the present invention.

FIG. 9 is a detailed flow chart of a wafer processing step in FIG. 8.

FIG. 10 illustrates a liquid-immersion exposure apparatus of related art.

### DESCRIPTION OF THE EMBODIMENTS

Exemplary embodiments of the present invention are described below with reference to the attached drawings.

### First Embodiment

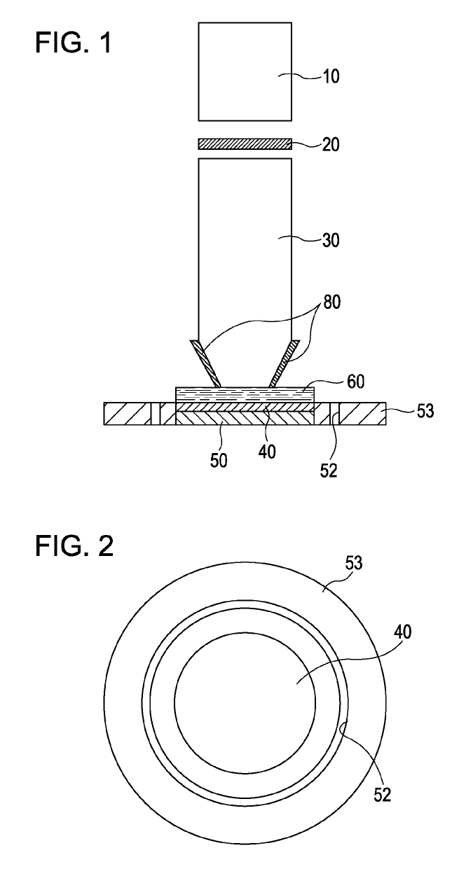

FIG. 1 schematically illustrates an exposure apparatus according to a first embodiment of the present invention. FIG. 2 shows a wafer 40 and an immersion-liquid retaining plate 53 included in the exposure apparatus shown in FIG. 1, as viewed from a reticle 20 side. In FIGS. 1 and 2, the reticle (mask) 20 serving as an original having a pattern drawn thereon is illuminated with a light beam from a light source (not shown) through an illumination system 10. The illumination system 10 is configured to shape the light beam from the light source to allow for uniform intensity distribution. The pattern on the reticle 20 is reduced in size by a projection optical system 30 before being projected onto the wafer 40. The projection optical system 30 and the wafer 40 have an immersion liquid 60 at least partially filled therebetween.

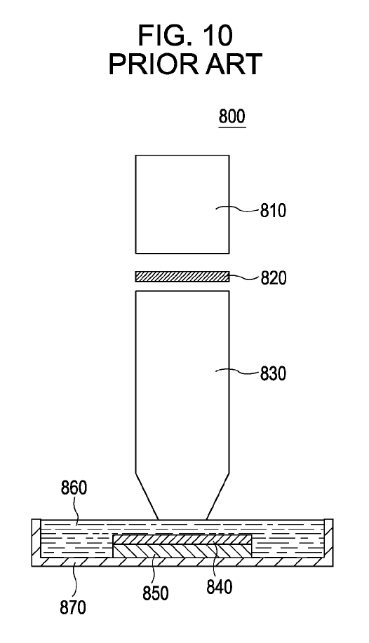

In contrast to the exposure apparatus 800 of the related art shown in FIG. 10 that has the immersion-liquid retaining container 870, the exposure apparatus according to the first embodiment is a local-fill liquid-immersion exposure apparatus and does not have an immersion-liquid retaining container.

To retain the immersion liquid 60 above the wafer 40, a supply port of an immersion-liquid supplying mechanism 80 is provided at a lower section of the projection optical system 30 in the first embodiment. The immersion-liquid supplying mechanism 80 may be constituted by a plurality of nozzles, a movable nozzle, or a ring-shaped nozzle. In this embodiment, the immersion-liquid supplying mechanism 80 is constituted by a plurality of nozzles. With a plurality of nozzles, the supplying direction of the immersion liquid 60 can be made adjustable in conformity to the moving direction of the wafer 40. By adjusting the supplying direction in this manner, the immersion liquid 60 can be retained below the lower surface of the projection optical system 30 while the wafer 40 is moved by a wafer stage 50. Thus, an immersion liquid containing no impurities can be supplied and retained between the lower surface of the projection optical system 30 and the wafer surface subjected to an exposure process, thereby augmenting exposure imaging performance.

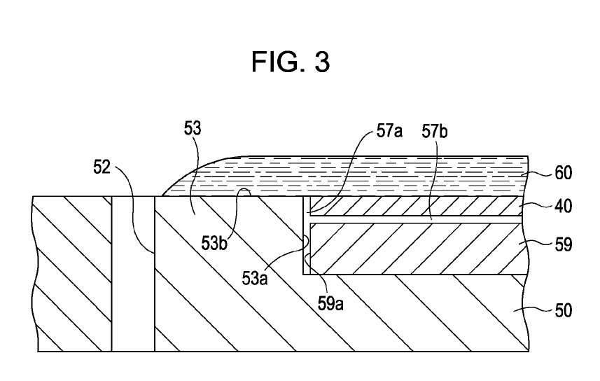

When the exposure process is finished, an excess immersion liquid from the exposure area is moved outward from the wafer 40 towards the immersion-liquid retaining plate (also called a liquid retaining portion or a liquid retaining surface) 53. The immersion-liquid retaining plate 53 is disposed such that its top surface will be substantially flush with the top surface of the wafer 40 during the exposure process. The immersion-liquid retaining plate 53 is configured to retain the immersion liquid 60 on the surface thereof together with the wafer 40. The immersion-liquid retaining plate 53 may be formed of a hydrophilic member or may at least have a surface 53b with a hydrophilic property (see FIG. 3). A hydrophilic member or a hydrophilic surface has a contact angle of 90° or less with respect to liquid.

The immersion-liquid retaining plate 53 has a recovery port defined by a slit 52 or by a plurality of holes. By vacuuming the recovery port from the lower surface of the immersion-liquid retaining plate 53, the immersion liquid 60 can be discharged through the recovery port, such as the slit 52.

With this configuration, however, there is still a possibility that the immersion liquid 60 may flow to the undersurface of the wafer 40 via a slight gap 57a (FIG. 3) between the wafer 40 and the immersion-liquid retaining plate 53. Should this happen, the immersion liquid 60 on the undersurface of the wafer 40 can possibly spill onto a wafer conveying path.

FIG. 3 is a schematic enlarged view of the wafer 40 and the immersion-liquid retaining plate 53 according to the first embodiment and their surrounding area. As shown in FIG. 3, the immersion-liquid retaining plate 53 retains the immersion liquid 60 on the surface thereof together with the wafer 40. However, as noted above, there is a slight gap 57a between the wafer 40 and the immersion-liquid retaining plate 53. The gap 57a also extends downward between the wafer chuck 59 and the immersion-liquid retaining plate 53. The immersion-liquid can flow into the gap 57a, as discussed more fully below. The gap 57a is determined in accordance with, for example, the processing accuracy of the wafer 40, the processing accuracy of the immersion-liquid retaining plate 53, and strain produced when the wafer 40 is secured onto the wafer stage 50 with a wafer chuck 59. The widest opening section of the gap 57a is a wafer notch section.

The immersion-liquid retaining plate 53 is formed such that the gap 57a is 5 mm at the wafer notch section and 2 mm at other sections surrounding the wafer 40. The wafer chuck 59 is composed of a hydrophilic porous ceramic material which prevents the immersion liquid 60 from remaining on the top surface of the wafer chuck 59. Moreover, a wall surface 53a of the immersion-liquid retaining plate 53 and a wall surface 59a of the wafer chuck 59 that faces the immersion-liquid retaining plate 53 are both formed so as to be entirely hydrophilic or to be entirely hydrophilic and porous. For example, the wall surface 53a of the immersion-liquid retaining plate 53 can be made of a stainless surface, an aluminum surface, or a KN plated surface, each of which provides a relatively small contact angle with immersion liquid.

The undersurface of the wafer 40 contacts a wafer portion (also called a contact portion) of the top surface of the wafer chuck 59, and the wafer chuck 59 is configured to attract and hold the wafer 40 in place with vacuum. Nonetheless, a slight gap 57b remains between the undersurface of the wafer 40 and the contact portion of the wafer chuck 59 into which the immersion-liquid can flow.

This phenomenon is believed to occur in the following manner. Specifically, when the immersion liquid 60 flowing from the wafer 40 side reaches the edge of the wafer 40, the immersion liquid 60 subsequently flows into the gap 57a and towards a surface 53b of the immersion-liquid retaining plate 53. Since the wall surface 53a is hydrophilic, the contact angle of the immersion liquid 60 with respect to the wall surface 53a is roughly the same as the contact angle of the immersion liquid 60 with respect to the surface 53b. Consequently, the immersion liquid 60 flows both along the surface 53b and likewise into the gap 57a.

As discussed above, the wafer chuck 59 is made of a hydrophilic porous material, thereby preventing the immersion liquid 60 from remaining on its top surface. Thus, when the wafer 40 is lifted upward, no immersion liquid is observed on the undersurface of the wafer 40.

More particularly, the contact portion of the wafer chuck 59 is made of a material that is hydrophilic. Thus, when immersion liquid 60 penetrates the gaps 57a and 57b, the contact portion of the wafer chuck 59 has a low contact angle (90° or less) with respect to it. Furthermore, the material of the contact portion of the wafer chuck 59 is also porous. So, even when the immersion liquid 60 penetrates the gaps 57a and 57b, very little to no immersion liquid 60 remains on the undersurface of the wafer 40. The first embodiment thus provides a liquid-immersion exposure apparatus that is resistant to failure even when an immersion liquid flows to the undersurface of a wafer.

Since the wafer chuck 59 is configured to attract and hold the wafer 40 with vacuum, the peripheral region of the wafer chuck 59 may alternatively be made of a non-porous material or may be given a treatment for blocking its pores, thereby assisting vacuum formation.

Although, in the first embodiment, the wall surface 53a of the immersion-liquid retaining plate 53 and a wall surface 59a of the wafer chuck 59 that faces the immersion-liquid retaining plate 53 are both formed so as to be entirely hydrophilic or be entirely hydrophilic and porous, alternatively, a similar effect to the first embodiment can be achieved by giving the hydrophilic treatment or the hydrophilic-porous treatment only to sections of the wall surfaces 53a and 59a that are close to the wafer 40. Like the first embodiment, each of these various alternatives provides a liquid-immersion exposure apparatus that is resistant to failure even when an immersion liquid flows to the undersurface of a wafer.

### Second Embodiment

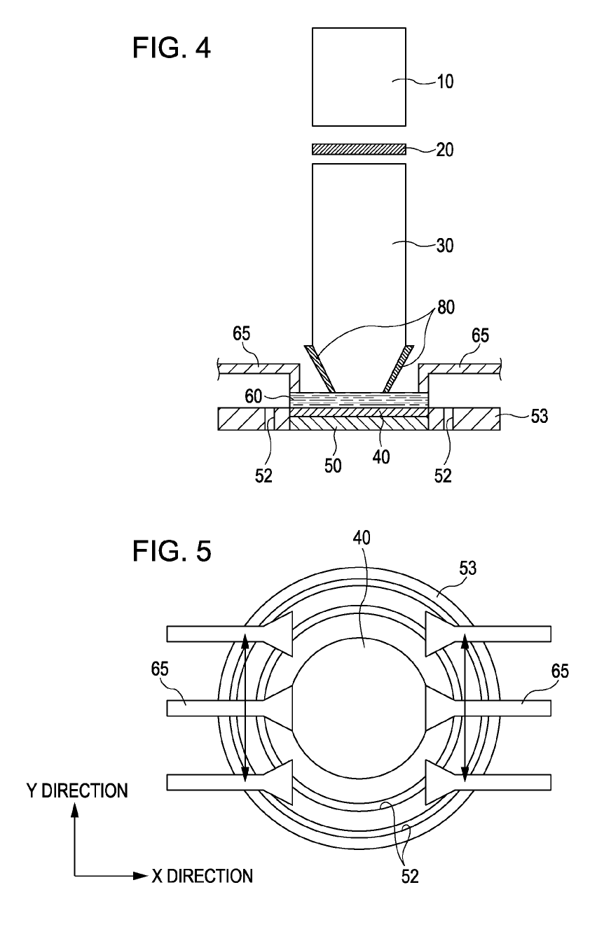

An exposure apparatus according to a second embodiment of the present invention has an enhanced capability to recover the immersion liquid as compared to the exposure apparatus according to the first embodiment. FIG. 4 schematically illustrates the exposure apparatus according to the second embodiment. Components in FIG. 4 that are the same as those in FIG. 1 are given the same reference numerals.

Currently, there are cases where the speed of the wafer stage is increased for the purpose of improving the process throughput of exposure apparatuses. The speed in that case is extremely high at about 500 mm/sec. In addition, to reverse the moving direction of the wafer at the edge of the wafer, an extremely high acceleration is generated.

Performing such an operation in a liquid-immersion exposure apparatus can cause the immersion liquid to spatter from the wafer. The second embodiment proposes a reliable technique for the recovery of the immersion liquid within the exposure apparatus. The supplying operation of the immersion liquid is performed in the same manner as in the first embodiment. Regarding the recovery technique for the immersion liquid, the second embodiment is provided with immersion-liquid recovering arms 65 (which serve as a liquid recovering mechanism) in addition to the slit 52 in the immersion-liquid retaining plate 53. The immersion-liquid recovering arms 65 are disposed so as to face the slit 52. Each immersion-liquid recovering arm 65 has a head made, for example, of a sponge-like porous material. In the second embodiment, a high-density polyethylene porous material is used for each of the heads. Alternatively, the head may be a structural component provided with a slit. By bringing such a porous object near or into contact with the immersion liquid 60, the immersion liquid 60 can be properly recovered. A pipe connectable to a vacuum line is connected to this porous head so that the immersion liquid 60 can be vacuumed into the pipe. The immersion-liquid recovering arms 65 are disposed at the projection optical system 30 side relative to the surface of the wafer 40 while being separated from the wafer 40 by a certain distance. The immersion-liquid recovering arms 65 are stationary with respect to the projection optical system 30, and thus when the wafer 40 is moved relative to the projection optical system 30, it 40 also moves relative to the immersion-liquid recovering arms

Referring to X and Y coordinates shown in FIG. 5, the wafer 40 moves the most in the X direction at the central region thereof. In the Y direction, the wafer 40 moves in a step-by-step fashion by a distance corresponding to the size of a circuit pattern to be transferred onto the wafer 40. If the wafer 40 has the moving conditions as described above, the immersion-liquid recovering arms 65 are movable relatively with respect to the wafer 40 only in the Y direction in FIG. 5.

For example, as the wafer 40 moves from left to right and the moving direction is subsequently reversed at the edge of the wafer 40, this reversing moment is when the immersion liquid 60 accumulates the most at the edge of the wafer 40, thus leaving immersion liquid 60 on the immersion-liquid retaining plate 53. In the case where a resist or an antireflection film on the resist is hydrophobic, the immersion liquid 60 may undesirably fly off the wafer 40 or the immersion-liquid retaining plate 53 in the form of droplets depending on the degree of hydrophobic property and the moving speed of the wafer stage 50. The role of the immersion-liquid recovering arms 65 is to recover these droplets of immersion liquid 60. If the moving speed of the wafer stage 50 is not high enough to cause the immersion liquid 60 to spatter or if the immersion-liquid contact surface has a low hydrophobic property, the slit 52 in the immersion-liquid retaining plate 53 as in the first embodiment may be sufficient for recovering the immersion liquid 60.

Supposing that the exposure apparatus has a combination of the extremely high hydrophobic resist or antireflection film on the resist and a high-speed wafer stage, the spattering of the immersion liquid 60 can still be prevented in the second embodiment. Specifically, this is achieved by arranging two recovery slits or two sets of holes concentrically to the wafer 40.

The wafer 40 used in this embodiment is Teflon®-coated so that the surface thereof is given a maximum hydrophobic property. The contact angle of this wafer 40 with respect to water is 110° or higher. An immersion-liquid recovery process was tested in the following manner. The wafer stage 50 was moved at a speed of 1000 mm/sec and then stopped to allow the immersion liquid 60 to spatter. Using a high-density polyethylene sponge disposed at the head of each immersion-liquid recovering arm 65 and the recovery slits, the spattered immersion liquid 60 was substantially completely recovered.

The liquid-immersion exposure apparatus according to the second embodiment is capable of recovering the immersion liquid 60 on the wafer 40 even when a fluorinated antireflection film having a high hydrophobic property is used on the wafer 40 and the wafer stage 50 is driven at a speed higher than or equal to that of the actual condition.

### Third Embodiment

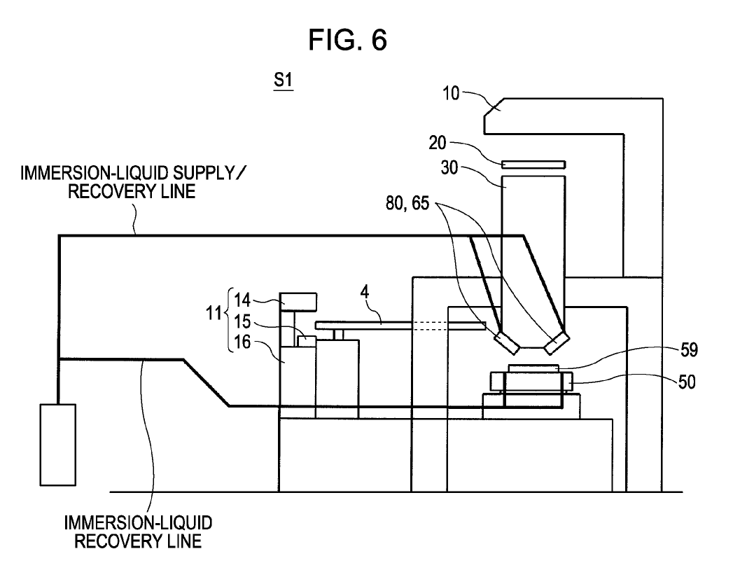

An exposure apparatus according to a third embodiment of the present invention has an enhanced countermeasure for the spattered immersion liquid 60 as compared to the exposure apparatus according to the first and second embodiments. FIG. 6 schematically illustrates the exposure apparatus according to the third embodiment. Components in FIG. 6 that are the same as those in FIG. 1 are given the same reference numerals.

The exposure apparatus according to the third embodiment includes a wafer stage 50 movable by a known six-axis drive table mechanism serving as a driver, a wafer chuck 59 disposed on the wafer stage 50, and a projection optical system 30 disposed above the wafer chuck 59. Light released from an illumination system 10 travels through a reticle 20 and the projection optical system 30 so as to reach a wafer (not shown), which is a substrate attached to the wafer chuck 59 by suction, whereby the resist on the surface of the wafer is exposed to the light.

The final lens of the projection optical system 30 and the wafer have liquid filled therebetween, and the supply and recovery operations of the liquid can be performed in the same manner as or alternatively a similar manner to the second embodiment shown in FIG. 4. A lens-system supporting member (lens base) and an area of the wafer stage 50 outside the wafer diameter are formed as a hydrophilic surface, a hydrophilic member, or a hydrophilic porous member. Consequently, should the liquid adhere to the lens-system supporting member or the area of the wafer stage 50 outside the wafer diameter, the liquid will be forced to move to other areas, thereby preventing the apparatus from rusting or from breaking down.

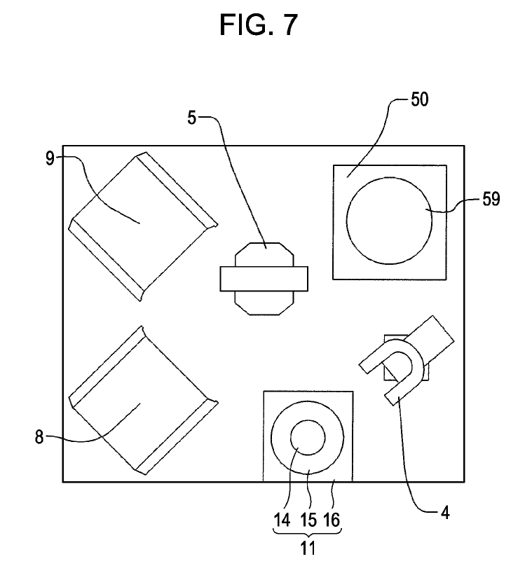

A scanner body shown in FIG. 6 has a substrate feeder device disposed adjacent thereto. The substrate feeder device is configured to perform automatic feeding and retrieving operations of the wafer. Referring also to FIG. 7, the substrate feeder device includes a feeder cassette 8 configured to hold wafers that have been conveyed thereto by, for example, a conveyor (not shown), and a pre-alignment unit 11 configured to perform a pre-alignment operation on wafers taken out from the feeder cassette 8 in a sequential fashion. The substrate feeder device also includes a carry-in arm (conveyor robot) 4 configured to convey a wafer having undergone a pre-alignment operation into the scanner body (not shown in FIG. 7). Moreover, the substrate feeder device also includes a robot (conveyor robot) 5 configured to alternately perform an operation for retrieving wafers having undergone an exposure-printing process from the scanner body and an operation for sequentially taking out wafers from the feeder cassette 8 and carrying the wafers into the pre-alignment unit 11 in a one-by-one fashion. Furthermore, the substrate feeder device includes a retrieval cassette 9 configured to hold the wafers that have been retrieved by the robot 5.

The pre-alignment unit 11 includes a pre-alignment stage 15, a pre-alignment-stage driver 16, and a position sensor 14. The wafer stage 50 holding the wafer and the substrate feeder device including the carry-in arm 4, etc. have wafer contact portions which include the carry-in arm 4, the robot 5, the wafer stage 50, the wafer chuck 59, and the pre-alignment stage 15. Each of these wafer contact portions is given a hydrophilic surface or is formed of a hydrophilic porous material. With such a hydrophilic surface or a hydrophilic porous material, the liquid can be prevented from being spattered toward other components even when the liquid gets transferred to or adhered to the wafer contact portions from the wafer. Consequently, even if the liquid flows to the undersurface of the wafer, is left on the undersurface of the wafer, or drips down onto the wafer stage 50 from an immersion-liquid supply port, spattering of the liquid toward other components can be minimized. Furthermore, the immersion-liquid supply port and the immersion-liquid recovering arms are similarly given a hydrophilic surface or formed of a hydrophilic porous material to prevent the liquid from spattering even when the liquid adheres to the supply port and the recovering arms.

A wafer taken out from the feeder cassette 8 by the robot 5 and placed on the pre-alignment stage 15 is aligned to a predetermined position by the pre-alignment unit 11. Subsequently, the wafer is carried to the wafer stage 50 in the scanner body by the carry-in arm 4.

Once the wafer stage 50 is returned to an exposure position, an alignment optical system (not shown) performs an alignment process on the wafer. Then, an exposure-printing process is performed on the wafer by a known method. The wafer having undergone the exposure-printing process is taken out from the scanner body by the robot 5 so as to be stored in the retrieval cassette 9. While the wafer is stored in the retrieval cassette 9 by the robot 5, the subsequent wafer undergoes the final alignment process and then the exposure-printing process in the scanner body. At the same time, the pre-alignment unit 11 performs the alignment process on the wafer subjected to the next exposure-printing process. The term “exposure process” in this case refers to a liquid-immersion exposure process. During this liquid-immersion exposure process, the projection optical system 30 and the wafer have liquid filled therebetween. The liquid can be recovered through a liquid recovery port. In this embodiment, a liquid that failed to be recovered through the liquid recovery port or that was non-recoverable through the liquid recovery port is prevented from being spattered to other areas. This is achieved by giving a hydrophilic surface to or using a hydrophilic porous material for areas that come into contact with the liquid, whereby the apparatus can be prevented from breaking down. The areas that come into contact with the liquid in the apparatus also include a lens periphery section of the projection optical system 30, in addition to those mentioned above.

### Fourth Embodiment

A fourth embodiment of the present invention is directed to a device manufacturing method using the above-described exposure apparatus.

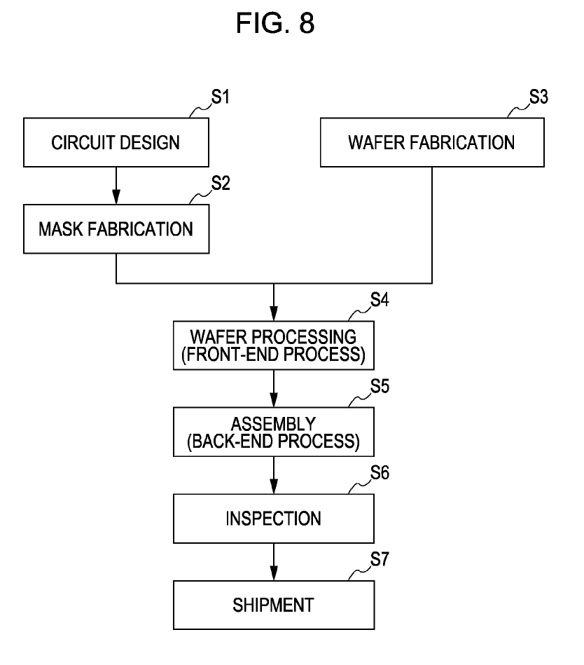

FIG. 8 is a flow chart illustrating a method for manufacturing a semiconductor device (e.g. a semiconductor chip such as an IC chip or an LSI chip, an LCD, or a CCD sensor).

Specifically, step S1 is a circuit design step for designing a circuit pattern of semiconductor chips. Step S2 is a mask fabrication step for fabricating a mask (reticle) having the designed circuit pattern. Step S3 is a wafer fabrication step for fabricating a wafer using a material such as silicon. Step S4 is a wafer processing step, which is referred to as a front-end process. In this step, actual circuits are formed on the wafer by lithography using the prepared mask and wafer along with any of the embodiments of the above-described exposure apparatus of the present invention. Step S5 is an assembly step, which is referred to as a back-end process. In this step, semiconductor chips are formed from the wafer obtained in step S4. Specifically, this step S5 includes an assembly process (dicing and bonding) and a packaging process (chip sealing). Step S6 is an inspection step for testing the semiconductor chips obtained in step S5 for, for example, operation and durability. The semiconductor chips are thus completed through the above steps, and are subsequently shipped in step S7.

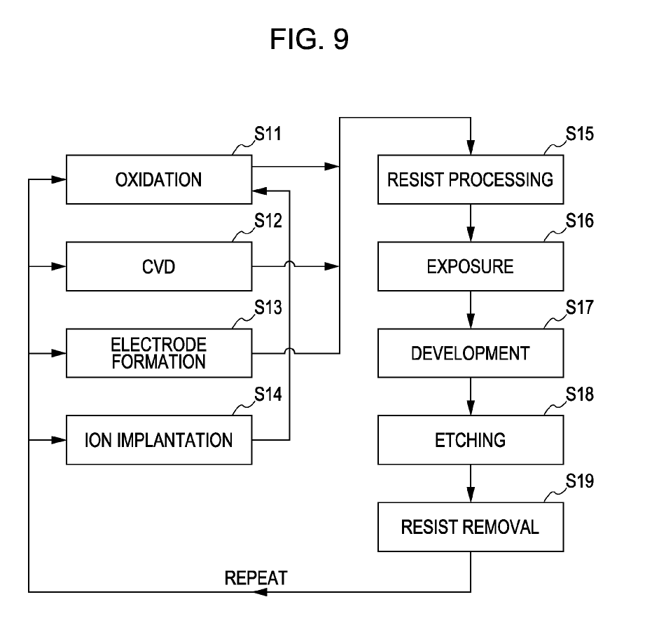

FIG. 9 is a detailed flow chart of the aforementioned wafer processing step. Specifically, step S11 is an oxidation step where the surface of the wafer is oxidized. Step S12 is a step for forming an insulating film on the surface of the wafer. Step S13 is an electrode formation step for forming electrodes on the wafer by vapor deposition. Step S14 is an ion implantation step for implanting ions into the wafer. Step S15 is a resist processing step for applying a resist layer (photosensitive agent) onto the wafer. Step S16 is an exposure step for printing the circuit pattern of the mask on the wafer by exposure using any of the embodiments of the above-described exposure apparatus of the present invention. Step S17 is a development step where the exposed wafer is developed. Step S18 is an etching step for etching away parts other than the developed resist image. Step S19 is a resist removal step for removing the resist that has become unnecessary after the etching step. By repeating these steps, a circuit pattern is formed on the wafer.

With the device manufacturing method according to the fourth embodiment, highly integrated devices can be manufactured, which was difficult in the past.

Accordingly, the present invention can provide a liquid-immersion exposure apparatus with better performance than prior art.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2007-178006 filed Jul. 6, 2007 and Japanese Patent Application No. 2008-159384 filed Jun. 18, 2008, which are hereby incorporated by reference herein in their entirety.

What is claimed is:

1. An exposure apparatus comprising:
a projection optical system configured to project light from an original onto a substrate,
a chuck configured to hold the substrate, and
a liquid supplying mechanism configured to fill a space between the projection optical system and the substrate with liquid,
wherein the chuck has a contact portion that is contactable with the substrate, and wherein at least the contact portion of the chuck has a surface having a contact angle of 90° or less with respect to the liquid.

2. The exposure apparatus according to claim 1, further comprising a liquid retaining portion configured to retain the liquid, the liquid retaining portion disposed in a region surrounding the substrate,
wherein at least one of a surface of the liquid retaining portion and a surface of a lens periphery section of the projection optical system has a contact angle of 90° or less with respect to the liquid.

3. The exposure apparatus according to claim 2, further comprising:
a conveyor robot configured to convey the substrate, and
a stage configured for aligning the substrate,
wherein a surface of the conveyor robot and a surface of the stage have a contact angle of 90° or less with respect to the liquid.

4. The exposure apparatus according to claim 1, wherein the contact portion comprises a hydrophilic member.

5. The exposure apparatus according to claim 1, wherein the contact portion comprises a hydrophilic porous member.

6. The exposure apparatus according to claim 5, wherein the chuck is capable of attracting and holding the substrate with vacuum, and wherein a periphery section of the chuck does not comprise a porous member.

7. The exposure apparatus according to claim 1, further comprising a liquid recovering mechanism configured to recover the liquid filled between the projection optical system and the substrate.

8. The exposure apparatus according to claim 7, wherein at least one of the chuck, a periphery section of a stage, and a conveyor robot has a non-contact portion that does not contact with the substrate, and wherein the non-contact portion comprises a hydrophobic portion.

9. The exposure apparatus according to claim 7, wherein the liquid recovering mechanism has a recovery port configured to recover the liquid from the substrate via a side of the substrate proximate to the projection optical system.

10. The exposure apparatus according to claim 9, further comprising a liquid retaining portion configured to retain the liquid, the liquid retaining portion being disposed in a region surrounding the substrate,
wherein the recovery port is disposed in the liquid retaining portion.

11. The exposure apparatus according to claim 9, wherein the recovery port is disposed in a region surrounding the chuck.

12. The exposure apparatus according to claim 1, further comprising a liquid recovering mechanism configured to recover the liquid from the substrate,
wherein the liquid supplying mechanism has a supply port configured to supply the liquid to the space at a side of the substrate proximate to the projection optical system, and
wherein the liquid recovering mechanism has a recovery port configured to recover the liquid from the substrate from that side of the substrate.

13. The exposure apparatus according to claim 7, wherein the liquid recovering mechanism includes a porous object, and wherein the liquid recovering mechanism recovers the liquid by bringing the porous object close to or into contact with the liquid.

14. The exposure apparatus according to claim 13, wherein the liquid recovering mechanism includes a vacuum pipe connected to the porous object, and wherein the liquid is recovered through the vacuum pipe.

15. The exposure apparatus according to claim 7, wherein the liquid recovering mechanism applies a vacuum to recover the liquid.

16. The exposure apparatus according to claim 7, further comprising:
a stage configured to be used for alignment of the substrate,
wherein the liquid recovering mechanism recovers the liquid from the substrate via a surface of the stage.

17. A device manufacturing method comprising:
exposing a substrate to light using the exposure apparatus according to claim 1, and
developing the exposed substrate.
